(19) United States
(12) Patent Application Publication
(10) Pub. No.: US 2024/0232741 A9
(43) Pub. Date: Jul. 11, 2024

(54) RESOURCE ASSIGNMENTS BASED ON STATION CONSTRAINTS

(71) Applicant: American Airlines, Inc., Fort Worth, TX (US)

(72) Inventors: Guodong Zhu, Irving, TX (US); Bosung Kim, Flower Mound, TX (US); Balaji Nagarajan, Irving, TX (US); Kuldeep Sharma, Fort Worth, TX (US); Bayli Waidelich, Flower Mound, TX (US); Allyson King, Irving, TX (US); Sumit Batra, Colleyville, TX (US); Shau-Shiang Sunny Ja, Euless, TX (US)

(21) Appl. No.: 17/971,272

(22) Filed: Oct. 21, 2022

(51) Int. Cl. G06Q 10/06

(52) U.S. Cl. CPC G06Q 10/06311

(57) ABSTRACT

A method for assigning a set of resources to a set of stations includes retrieving a set of pre-determined resource assignments; generating a set of resource assignment copies; receiving a resource constraint for the set of resources and a station constraint for the set of stations; assigning a set of first weights to the set of pre-determined resource assignments and a set of second weights to the set of resource assignment copies; determining at least one set of possible resource assignments that satisfies the resource constraint; determining a total weight for each set; determining a set of solution resource assignments as a set of the at least one set of possible resource assignments having a lowest total weight; and autonomously presenting the set of solution resource assignments on at least one display.

### BACKGROUND

Assigning aircraft to gates is generally a manual process that requires an extensive knowledge and understanding of the particular airport, as well as a substantial amount of trial and error.

### BRIEF DESCRIPTION OF THE DRAWINGS

FIG. 1 is a diagrammatic view of an example system 100 for assigning resources to stations.

FIG. 2 is an example schedule of assignments and copies of assignments.

FIG. 3A is an example first selection of assignments and copies of assignments that may be infeasible based to one or more constraints.

FIG. 3B is example second selection of assignments and copies of assignments that may be feasible based to one or more constraints.

FIG. 4 is a flow chart illustrating an example method of assigning a set of resources to a set of stations.

FIG. 5 is a flow chart illustrating an example method of assigning an aircraft to a gate.

FIG. 6 is a diagrammatic view of an example system for balancing resource assignments across various stations.

FIG. 7 is a diagrammatic view of an example embodiment of a user computing environment.

### DETAILED DESCRIPTION

Known aircraft-to-gate assignment systems do not adequately account for separation between flight assignments. This often leads to overlapping gate assignments on one hand, or to underutilized gates on the other. A novel recommendation system according to the present disclosure may improve upon known systems and methods by iterating different combinations of aircraft-to-gate assignments with varying amounts of buffer, and selecting the combination that provides a maximum amount of separation between assigned aircraft at the same gate while satisfying constraints placed on the assignment. The novel recommendation system may further improve upon known systems by refining the selected combination based on one or more preferences or system objectives.

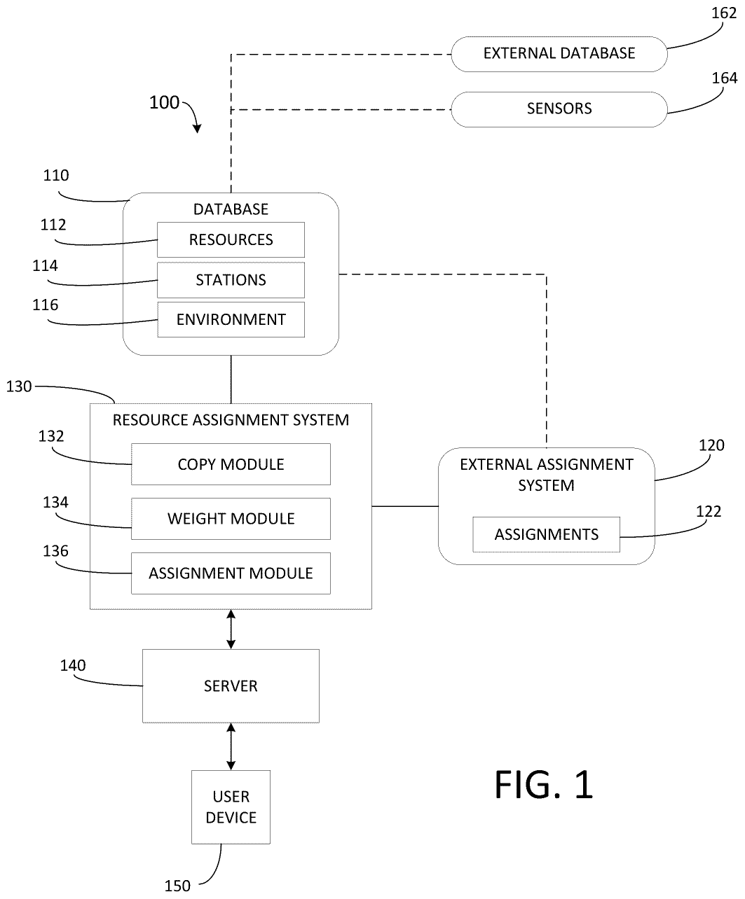

Referring now to the drawings, wherein like numerals refer to the same or similar features in the various views, FIG. 1 is a diagrammatic view of an example system 100 for assigning resources to stations. The system 100 may include a database 110, an external assignment system 120, and a resource assignment system 130 that may include one or more functional modules 132, 134, and 136 embodied in hardware and/or software. In an embodiment, the functional modules 132, 134, and 136 of the resource assignment system 130 may be embodied in a processor and a memory (i.e., a non-transitory, computer-readable medium) storing instructions that, when executed by the processor, cause the processor to perform the functionality of one or more of the functional modules and/or other functionality of this disclosure.

The database 110 may include stored data regarding a set of resources 112, a set of stations 114, and an environment 116 in which the resources 112 and stations 114 may operate. The resources 112 may include any resource that is capable of providing a service when paired with a station (e.g., from the set of stations 114). For example, the resources 112 may include aircraft that are capable of receiving and boarding customers when paired with a gate. In another example, the resources 112 may include trains or other vehicles that can be paired with a train station, cab stand, etc. The data stored within the set of resources 112 may include a type of each resource, a beginning time (e.g., on-time, in-time, etc.) for each resource, an ending time (e.g., off-time, out-time, etc.) for each resource, a changeover time for each resource, an origin and/or destination of the resource, and any other characteristic of each resource that could be used to assign the resources to stations. In those embodiments in which the resources are aircraft, the type of each resource may include a flight type (e.g., domestic, international), a model of aircraft, an operator of the aircraft, and a size of the aircraft. In some embodiments, each aircraft may be assigned a pair of flights, with a first flight of the pair being an arriving flight, and the second flight of the pair being a departure flight. The beginning time and ending time of each aircraft may be based in part on an arrival and departure time (respectively) for the pair of flights assigned to the aircraft. The beginning time and ending time may be the same as the arrival and departure time, or the beginning time and ending time may include an amount of time before the arrival time and/or after the departure time to account for taxiing or for possible delays, and may be a flat amount added to all aircraft or may be variable based on one or more characteristics of the aircraft. The beginning time and ending time of each aircraft may be visualized as a block or “puck” on a calendar, with the size of the puck reflecting the amount of time between the beginning time and ending time (e.g., the minimum gate occupancy time of the flight/aircraft).

These resource 112 data may be stored by and/or received from an external database 162. In embodiments in which the resources 112 are aircraft, the external database 162 may be a flight operating system (“FOS”) associated with a particular airline that has information regarding each flight operated by the airline. The external database 162 may also include a database that has information regarding flights from multiple airlines (e.g., Official Airline Guide (“OAG”)). By leveraging data from this external database 162, the system 100 may improve on existing scheduling systems by drawing inputs from varied sources instead of requiring data entry directly into the system or relying on pre-arranged assignments.

Resource 112 data may also be provided by one or more sensors 164 positioned throughout the airport. In embodiments in which the resources 112 are aircraft, sensors 164 may be included on a jetway to detect when aircraft are present or not to monitor gate data (e.g., occupancy). Sensors 164 included with each aircraft may similarly provide occupancy data, as well as real-time runway occupancy, which may be used to establish beginning and ending times for each aircraft. In another example, the sensors 164 may include one or more visual sensors (e.g., video surveillance cameras, proximity sensors, etc.) to provide data indicative of passenger movement or presence at points throughout the airport, which may be leveraged to determine gate availability. By generating inputs to the system 100 from real-time data from sensors 164, the system 100 may integrate its scheduling methods into a practical application by grounding the system 100 in physical world data (e.g., passenger flow, station availability based on resource presence, etc.).

In some embodiments, the changeover time of each aircraft may be based in part on an amount of time required to prepare the aircraft for switching from the first assigned flight (e.g., the arrival flight) to the second assigned flight (e.g., the departure flight). In some embodiments, the changeover time may be based in part on the type of aircraft (e.g., a larger model of aircraft requires a longer changeover than a smaller model), while in other embodiments, the changeover time may be determined as the difference between arrival and departure times. The changeover time may further be based on a tow time (e.g., an amount of time to pull or tow the aircraft to the gate from a hangar).

The stations 114 may include any station that is capable of allowing a service to be performed when paired with a resource (e.g., from the set of resources 112). For example, the stations 114 may include gates at a commercial airport that are configured to receive an aircraft to enable the aircraft to unload passengers at the airport and to receive new customers. In another example, the stations 114 may include train stations, cab stands, bus stops, or other stops or spots that can receive a vehicle. The data stored within the set of stations 114 may include a capacity of the station, a compatibility of the station with each resource, a type of equipment at the station, an operator of the station, any characteristics or attributes unique to the station that could restrict traffic, a maintenance status of the station, and any other characteristic of each station that could be used to assign resources to the stations 114. In those embodiments in which the stations 114 include gates at a commercial airport, the capacity of each gate may include a size of each gate and the ability of each gate to receive aircraft of various sizes. For example, a particular gate may be too small to receive a widebody aircraft, and the stored capacity data associated with this gate would reflect this reduced capacity. In some embodiments, the type of equipment may include jetway (or lack thereof), luggage loading carts, and stairs for deplaning on the runway. The operator of the station may include the airline(s) that may have authority to operate at each gate, or may have an expressed preference to operate at each gate. In some embodiments, the unique characteristics may include one-way alleys or other similar restrictions due to the particular layout of the commercial airport. For example, if a particular gate is located in the end of an alley that is wide enough for only a single aircraft at a time, the stored restriction data associated with the particular gate would reflect that aircraft that would conflict with aircraft at other gates in the alley cannot be assigned to the particular gate, due, for example, to anticipated timing conflicts with the use of the alley. This may be referred to as “push-back” conflicts due to one aircraft being unable to push back from the gate due to the presence of another aircraft in its path. The maintenance status of the gate may include whether the gate is affected in part or in whole by maintenance activities.

The environment 116 may include the space within which the stations 114 are positioned, and the stored data may include any characteristics of the environment 116 that could affect the assignments of resources 112 to stations 114. For example, the environment 116 may be a commercial airport, a central terminal, a factory, etc. If the environment 116 is a commercial airport, the stored data may include a particular shape, layout or orientation of the gates that could affect push-back or taxiing lanes, a layout or orientation (relative to the stations 114) of a storage hangar that could affect tow times, and a layout or orientation of runways and landing direction that could affect balancing, as well as any weather or similar data. In some embodiments, the environment 116 data may include pre-determined (or predicted) runway assignments for the resources 112. These data may be stored by and/or received from an internal database unique to the environment 116, as well as from a central database (e.g., external database 164) maintained by a supervisory entity, such as the Federal Aviation Administration (FAA) System-Wide Information Management (SWIM) system.

The external assignment system 120 may be any pre-existing computer-implemented and/or human-operated system for assigning resources to stations. For example, the external assignment system 120 may be a computing system that receives various resources (e.g., resources 112) and various stations (e.g., stations 114), and that outputs a set of assignments 122 that matches each resource with a station. However, the assignments 122 may be agnostic to any characteristics of either resources or stations, and may include errors or assignments that are not feasible. Regardless of these errors and other issues, the assignments 122 may serve as a starting point for the resource assignment system 130 to alter and refine in order to improve the set of assignments. In some embodiments, the external assignment system 120 may be omitted entirely, such that there are no pre-existing assignments 122 or that the assignments 122 are received or generated elsewhere. In these embodiments, the assignments 122 may be generated by the system 100 based on data about the resources 112 and/or stations 114. For example, the resources 112 may include beginning and ending times for each resource 112, such that the assignments 122 may be resources 112 without specific stations 114. In another example, the assignments 122 may be assignments from a previous run of the resource assignment system 130, such that the input to the resource assignment system 130 is a previous output (e.g., from earlier in the day).

The functional modules 132, 134, and 136 of the resource assignment system 130 may include a copy module 132 that is configured to generate one or more virtual copies of the assignments 122, with each virtual copy including an amount of copy buffer to simulate a longer occupancy time (e.g., a larger puck) or a shorter occupancy time (e.g., a smaller puck) for the assignments 122. The amount of copy buffer may be pre-defined for each copy, such that each iteration of copy (e.g., first copy, second copy) includes the same amount of copy buffer as all other same-iteration copies of assignments 122. For example, the first copy generated by the copy module 132 for each assignment 122 may add 5 minutes of copy buffer, the second copy may add 10 minutes of copy buffer, etc. Alternatively, the amount of copy buffer may be based in part on the un-copied (or minimum) occupancy time for each assignment 122, such that each iteration of copy includes a scaled amount of copy buffer. For example, the first copy generated by the copy module 132 for each assignment 122 may add 5% of the minimum occupancy time as copy buffer, the second copy may add 10% of the minimum occupancy time as copy buffer, etc. Although examples herein only describe the generation of a limited number of pucks, it should be understood that the generation of any number of pucks is within the scope of this disclosure.

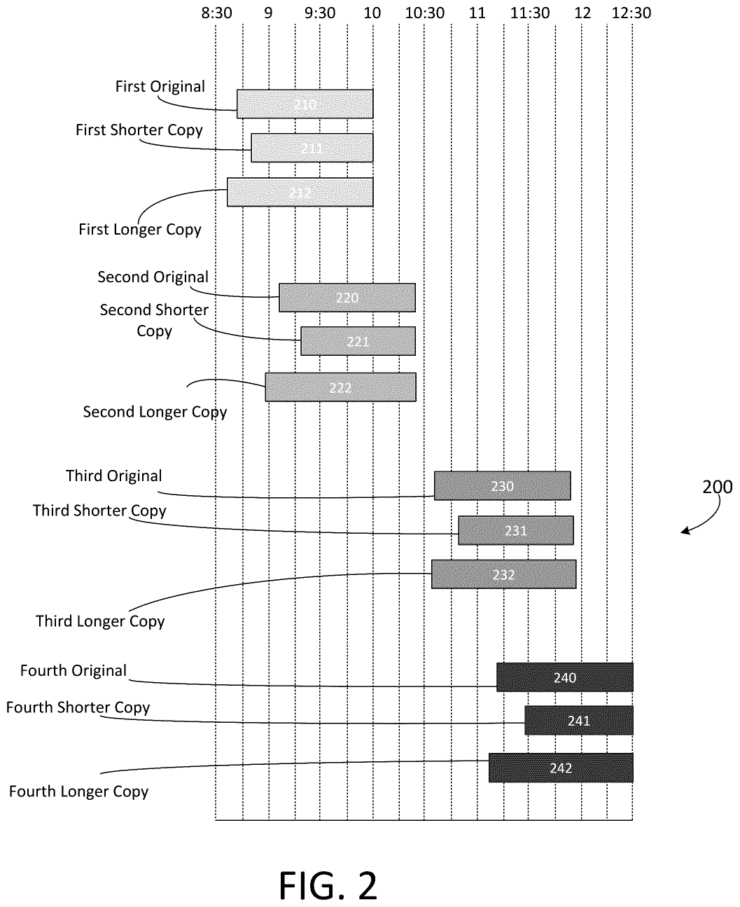

FIG. 2 is an example schedule of pucks and copies generated by the copy module 132. As shown, a first original 210 may be a puck of a first assignment (e.g., from assignments 122) and may include a base amount of buffer. For example, if the resource associated with the first original 210 has an on-time of 9 and an off-time of 10, the base amount of buffer may be 15 minutes, such that the first original 210 extends from 8:45 to 10. From the first original 210, a first shorter copy 211 may be generated to include an amount of copy buffer (e.g., 1 minute of buffer) less than the base amount of the first original (such that the first shorter copy 211 has a shorter length than the first original 210). A first longer copy 212 may be generated to include an amount of copy buffer (e.g., 30 minutes of buffer) more than the base amount of the first original (such that the first longer copy 211 has a longer length than the first original 210). Second original 220, third original 230, and fourth original 240 are, similar to the first original 210, may be pucks of second, third, and fourth assignments respectively, and may each include the same base amount of buffer as the first original. Second shorter copy 221, third shorter copy 231, and fourth shorter copy 241 are similar to the first shorter copy 211, and second longer copy 222, third longer copy 232, and fourth longer copy 242 are similar to the first longer copy 212.

The functional modules 132, 134, and 136 of the resource assignment system 130 may also include a weight module 134 configured to determine one or more weights (e.g., costs) for assigning each resource 112 to each station 114 based on characteristics of the resources 112 and of the stations 114, as well as on an amount of copy buffer (if any). In one embodiment, lower weights may be determined for and assigned to those resources 112 or resource copies that are preferred (e.g., have one or more characteristics that are aligned with system-wide goals), regardless of the associated station 114. For example, assignment 122 copies with higher copy buffer may be given lower weights because increasing an amount of separation between resources 112 assigned to the same stations 114 is a system-wide goal. Accordingly, assignment 122 without any copy buffer may be given higher weights. In one embodiment, higher weights may be determined for and given to those resource-station assignments that are incompatible based on characteristics of the associated resource 112 and/or of the associated station 114. For example, if a particular resource 112 is too large to appropriately interact with a particular station 114 (e.g., a widebody aircraft and a small gate), the weight given to that particular resource-station assignment may be relatively high, regardless of the amount of copy buffer. In another example, if a particular resource 112 is associated with a higher priority task (e.g., an aircraft on an international flight), the weight given to that particular resource-station assignment may be relatively low.

In some embodiments, the weight module 134 may receive pre-determined weights for each resource-station assignment. In other embodiments, the weight module 134 may dynamically determine the weight for each resource-station assignment based on the characteristics of the resources 112 and stations 114. For example, the weight module 134 may include an algorithm and/or a trained machine learning model that receives the resources 112, copies from the copy module 132, and the stations 114, and outputs weights for each assignment. The machine learning model may be trained using training data that includes user-generated weights for various resource-station assignments, such that the machine learning model may derive relationships between resource-station assignment characteristics and weights.

The functional modules 132, 134, and 136 of the resource assignment system 130 may also include an assignment module 136 configured to determine various sets of resource-to-station assignments that satisfy established constraints, determine a total weight associated with each set, and present the set having a lowest total weight. The established constraints may be pre-determined and received by the assignment module 136, and may be based in part on a particular environment 116 (e.g., airport) in which the resources 112 and stations 114 operate. For example, the particular layout of the environment 116 may not permit two resources 112 to be assigned to adjacent or nearby stations. In an example in which the resources 112 are aircraft and the stations 114 are airport gates, some combinations of aircraft and gates may lead to push-back conflicts, such that the layout of the airport and orientation of the gates prevents two or more aircraft from pushing-back from their gates at the same time.

Other constraints may be applied regardless of the environment 116 in which the resources 112 and stations 114 operate, such that the constraints are included in each iteration of the system 100. One such constraint may be that each resource 112 be assigned to only one station 114. For an example in which the resources 112 are aircraft and the stations 114 are airport gates, this constraint may prevent a single aircraft being assigned to multiple gates, which would cause confusion for all parties involved and may create a physical impossibility. Another such constraint, which may be inherent to the system 100 due to the copy module 132, may be that only one assignment is made for each resource 112 and its copies. Because each copy generated by the copy module 132 only adds some amount of copy buffer, the underlying resource 112 that provides the basis for the copy may be unchanged, and the copy may still be representative of the resource 112. As such, this constraint prevents the original resource 112 from being assigned to one station 114 and then a copy of that same resource 112 being assigned to a different station 114.

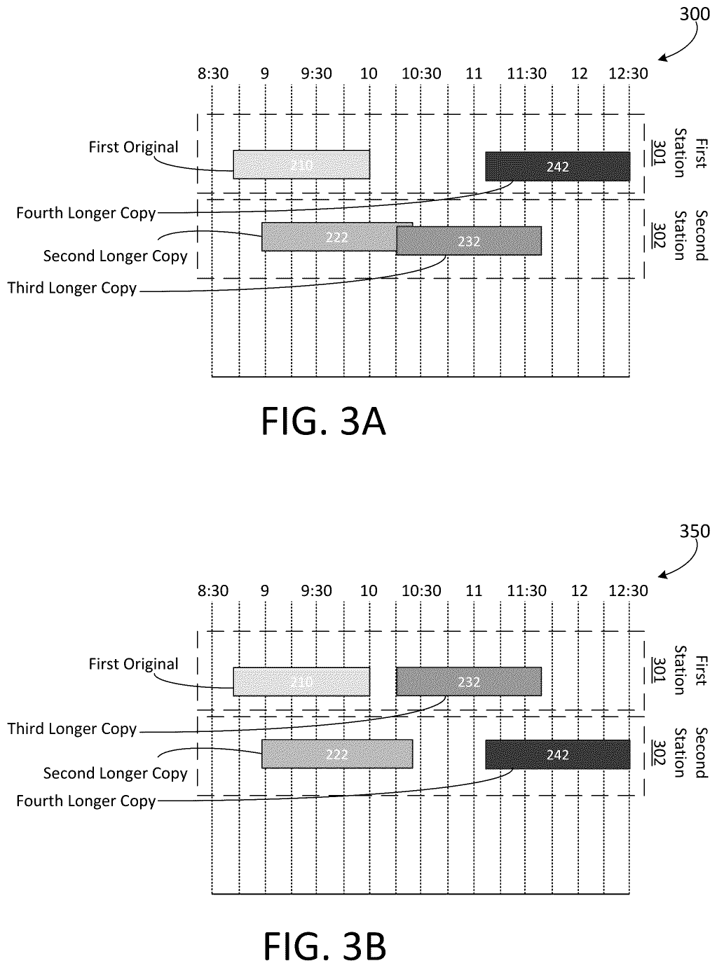

FIG. 3A is an example first selection 300 of pucks and copies that may be infeasible based to one or more constraints. As shown, the selection includes the first original 210 and the fourth longer copy 242 assigned to a first station 301, and the second longer copy 222 and the third longer copy 232 assigned to a second station 302. Although the first original 210 and the fourth longer copy 242 have a sufficient amount of separation at the first station 301, the second longer copy 222 and the third longer copy 232 overlap at the second station 302. As such, the first selection 300 violates a constraint against two resources being assigned to the same station at the same time.

FIG. 3B is example second selection 350 of pucks and copies that may be feasible based to one or more constraints. As shown, the selection includes the first original 210 and the third longer copy 232 assigned to the first station 301, and the second longer copy 222 and the fourth longer copy 242 assigned to the second station 302. In contrast to the first selection 300, there is sufficient separation between resources at both the first station 301 and the second station 302. As such, the second selection 350 does not violate the constraint against two resources being assigned to the same station at the same time.

Once the assignment module 136 has generated one or more possible assignment sets that satisfy the constraint(s), the assignment module 136 may determine a total weight of the assignments in each possible assignment set. The weight of each assignment may be from the weight module 134, and may be based in part on one or more characteristics of each assignment and indicative of the assignment's alignment with system-wide goals. The total weight, then, may be indicative of the particular possible assignment set's alignment with system-wide goals, with an overall lower weight associated with a more-aligned set. As such, the assignment module 136 may select the set with the lowest total weight as the solution set, and may present that solution set to a user (e.g., via the user device 150).

The system 100 may further include a server 140 in electronic communication with the resource assignment system 130 and the user computing device 150. The server 140 may provide a website, data for a mobile application, or other interface through which the user of the user computing device 150 may interact with the resources 112 and stations 114 stored within database 110 (e.g., to view possible assignments, assign particular weights, etc.). In some embodiments, the server 140 may receive an indication of a solution set for resource-station assignments, and present the solution set to the user (e.g., through the interface).

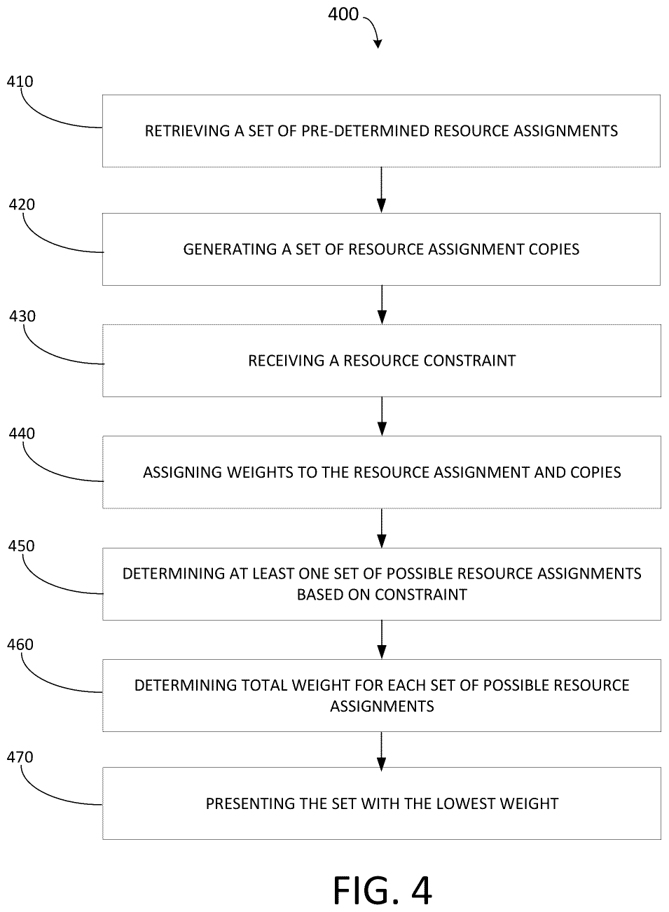

FIG. 4 is a flow chart illustrating an example method 400 of assigning a set of resources to a set of stations. The method 400, or one or more portions of the method 400, may be performed by the system 100, and more particularly by the resource assignment system 130, in some embodiments.

The method 400 may include, at block 410, retrieving a set of pre-determined resource assignments. These pre-determined resource assignments may be assignments 122 and may be received from the external assignment system 120. Each assignment 122, as described above, may include a combination of resource 112 and station 114, and may have been made agnostic to any characteristics of either resource 112 or station 114. In some embodiments, block 410 is omitted, such that the method 400 may be performed without first receiving resource assignments from an external system.

The method 400 may include, at block 420, generating a set of resource assignment copies. This block 420 may be performed by the copy module 132, and each copy may add an amount of copy buffer to each assignment 122. As described above with reference to the copy module 132, the amount of copy buffer may be a fixed amount added in each iteration of copy, such that the first copy of each assignment 122 may include a first amount of copy buffer and the second copy of each assignment 122 may include a second (e.g., greater) amount of copy buffer, etc. The amount of copy buffer may also be a scaled amount added in each iteration of copy, such that the first copy of each assignment 122 may include a first percentage of occupancy time as copy buffer and the second copy of each assignment 122 may include a second (e.g., greater) percentage of occupancy time as copy buffer, etc. All copies of each assignment 122 may continue to be associated with the original assignment to avoid assigning multiple copies of the same assignment to different stations, which is described in greater depth below with regard to blocks 430 and 450.

The method 400 may include, at block 430, receiving at least one resource constraint. The at least one resource constraint may be based in part on characteristics of the resources 112, as well as of the stations 114. As described above with reference to the assignment module 136, the constraints may be pre-determined and based on a particular environment 116 (e.g., airport) in which the resources 112 and stations 114 operate. For example, the particular layout of the environment 116 may not permit two resources 112 to be assigned to adjacent or nearby stations. Other constraints may be applied regardless of the environment 116 in which the resources 112 and stations 114 operate, such that the constraints are included in each iteration of the system 100. One such constraint may be that each resource 112 be assigned to only one station 114. For an example in which the resources 112 are aircraft and the stations 114 are airport gates, this constraint may prevent a single aircraft being assigned to multiple gates.

The method 400 may include, at block 440, assigning a set of weights to the resource assignments and to the resource assignment copies. As discussed above with reference to the weight module 134, the set of weights may be based in part on one or more characteristics of the resources 112, the stations 114, and the assignments 122, as well as an amount of copy buffer (if any). In one embodiment, lower weights may be given to those assignments that align more closely to system-wide goals, such as increased separation between resources assigned to the same station. For example, assignment copies with relatively greater amounts of copy buffer may be given lower weights than the original assignments 122 and assignment copies with relative less amounts of copy buffer. In one embodiment, higher weights may be given to those assignments with resources and/or stations that conflict. For example, if a station does not have the ability to receive a particular type of resource, the weight given to such an assignment may be high to discourage the assignment.

The method 400 may include, at block 450, determining at least one set of possible resource assignments that satisfy the at least one resource constraint. Each set of possible resource assignments includes assignments and copies of assignments from the copy module 132. In an embodiment in which a constraint is that only one version (e.g., original, first copy, second copy, etc.) of each assignment is included in the final set, each set may include only one assignment or copy associated with each of the original assignments 122. In some embodiments, a fixed number of sets of possible resource assignments may be pre-determined, such that the system 100 generates sets of possible resource assignments until the fixed number is met. In other embodiments, the system 100 may generate all sets of possible resource assignments, such that the system 100 does not stop until all permutations are analyzed for compliance with the constraint(s).

The method 400 may include, at block 460, determining a total weight for each set of possible resource assignments and, at block 470, presenting the set of possible resource assignments having the lowest total weight. The total weight may be the sum of the weights assigned at block 440 to each assignment or assignment copy included in the set of possible resource assignments. The set of possible resource assignments having the lowest total weight may be identified as the set of solution resource assignments (e.g., solution set 138 of FIG. 4), and may be presented to a user via the user device 150. The presentation may be of the set of solution resource assignments in list form or in a calendar form, with each assignment visualized as a puck occupying a station. The presentation may also be of the changes from the originally-received assignments 122 to the set of solution resource assignments, such that the presentation shows only the differences. This type of presentation could be used to focus on what needs to be addressed and to identify patterns in the changes in order to anticipate or adjust going forward.

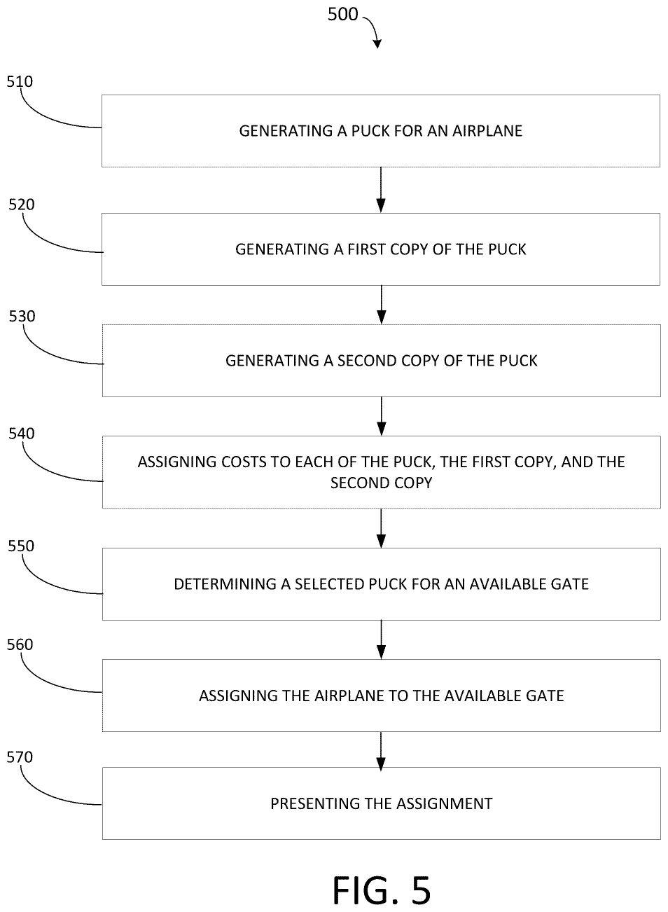

FIG. 5 is a flow chart illustrating an example method 500 of assigning an aircraft to a gate. The method 500, or one or more portions of the method 500, may be performed by the system 100, and more particularly by the resource assignment system 130, in some embodiments.

The method 500 may include, at block 510, generating a “puck” for the airplane. The puck may be based in part on an arrival time of the aircraft, a departure time of the aircraft, and/or a turnover (e.g., changeover) time for the aircraft. Puck refers to a visualization of the aircraft on a calendar, with a block of time reserved for the aircraft viewed as a puck-shaped rectangle or block.

The method 500 may include, at block 520, generating a first copy of the puck and, at block 530, generating a second copy of the puck. Each copy of the original puck may include an amount of copy buffer, with the first copy having a first amount and the second copy having a second amount greater than the first amount. As such, the original puck reflects an unchanged occupancy time (e.g., amount of time the aircraft is occupying the gate), while the first copy reflects a slightly longer occupancy time, and the second copy reflects an even longer occupancy time. By generating copies with increasing amounts of buffer built in, the feasibility or possibility of greater amounts of separation between resource assignments at the same gate can be tested without disrupting operations (e.g., without having to physically move resources around to test changes).

The method 500 may include, at block 540, assigning costs to each of the puck, the first copy, and the second copy. These costs, like the weights from the weight module 134 and from block 440 of the method 400, reflect alignment of each puck with a system-wide goal. In particular, the costs are indicative of a value placed on increasing separation between assignments, so lower costs may be assigned to pucks with greater amounts of buffer, while higher costs may be assigned to pucks with less (or no) buffer. For example, the cost assigned to the original puck may be higher than the cost assigned to the first copy, which may, in turn, be higher than the cost assigned to the second copy. In another example, if pre-existing assignments (e.g., from the external assignment system 120, from a run of method 500 earlier in a time period, etc.) are to be prioritized, a higher cost may be assigned to each puck that would cause a change from the pre-existing assignment, in order to de-incentivize changes to the schedule.

The method 500 may include, at block 550, determining a selected puck for an available gate and, at block 560, assigning the aircraft to the available gate. The selected puck may be any of the original puck, the first copy, or the second copy, and may be determined as the single puck of these three that has the lowest cost while satisfying any constraint(s). Although only three pucks are described in this example, it should be understood that any number of pucks may be generated (e.g., repeating blocks 520 and 530), and the determination at block 550 may take into account all of the pucks generated. As described above with reference to block 430 of the method 400, the constraint(s) may be based in part on the environment 116 in which the resources 112 and stations 114 operate, may be based on (or particular to) the available gate, and may be inherent to the system. For example, if the constraint requires that only one version of a puck be assigned, then the selected puck at block 550 is the version of the puck with the lowest cost (e.g., the second copy). In another example, if the constraint requires that the assigned puck be clear by a certain time due to space (e.g., pushback) issues and the amount of copy buffer added to the second copy would not allow the assigned puck to be clear by the certain time, then the selected puck at block 550 is the version of the puck with the lowest cost that fits within the time allotted (e.g., the first copy). Once a puck is determined as the selected puck, it may be assigned to the available gate.

The method 500 may include, at block 570, presenting the assignment. The presentation may be via the user device 150, and may include information about the selected puck, as well as information about other pucks. To this end, the method 500 may be repeated for each assignment 122 received from the external assignment system 120.

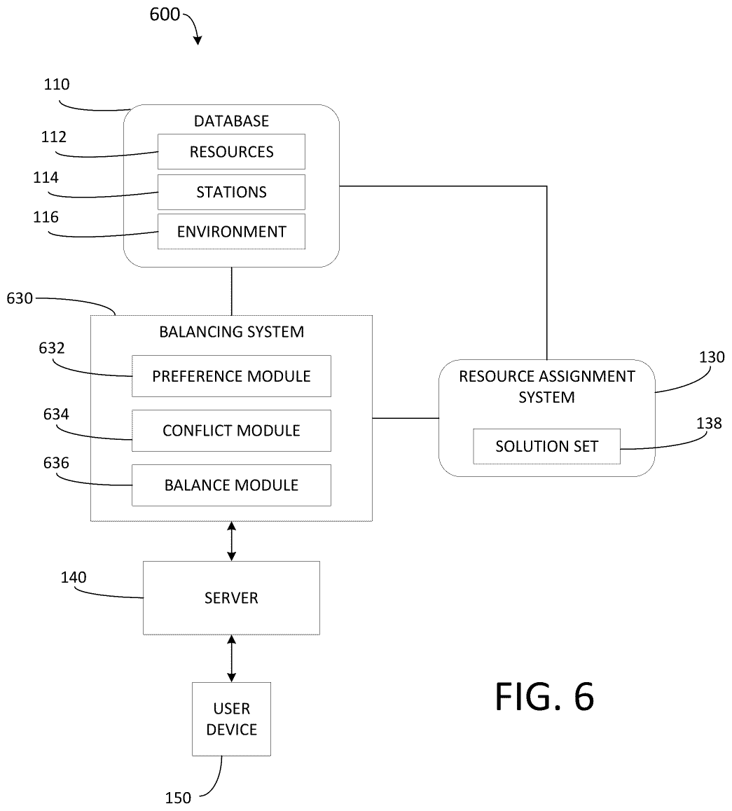

FIG. 6 is a diagrammatic view of an example system 600 for balancing resource assignments across various stations. The system 600 may run with the system 100 in order to provide a two-stage solution to resource scheduling. In some embodiments, the system 600 may run in parallel with the system 100, such that outputs from the system 100 may be inputs to the system 600 in real-time. In other embodiments, the system 600 may run in series with the system 100, such that the system 600 may not run until the system 100 has concluded its run. For example, the system 100 may, in the first stage, optimize resource-station assignments based on one or more constraints. From there, the system 600 may, in the second stage, re-distribute (or balance) the assignments from the first stage based on one or more preferences. The system 600 may include the database 110, the resource assignment system 130, and a balancing system 630 that may include one or more functional modules 632, 634, and 636 embodied in hardware and/or software. In an embodiment, the functional modules 632, 634, and 636 of the balancing system 630 may be embodied in a processor and a memory (i.e., a non-transitory, computer-readable medium) storing instructions that, when executed by the processor, cause the processor to perform the functionality of one or more of the functional modules and/or other functionality of this disclosure.

The functional modules 632, 634, and 636 of the balancing system 630 may include a preference module 632 configured to receive one or more preferences, and generate costs for each assignment based on the received preferences. The preferences may be pre-determined and based on the environment 116, such that the data stored in the database 110 regarding the environment 116 includes preference data. The preferences may also be received from a user (e.g., via the user device 150). The one or more preferences may be regarding a distribution of resources 112 across stations 114 (e.g., relatively even split of aircraft being assigned to terminal 1 and terminal 2, clustering aircraft with the same operator in the same set of gates, etc.), and ordering departures to facilitate unidirectional traffic. The preferences may be regarding optional (e.g., not required for operation) interactions between resources 112 and stations 114. For example, there may be a preference to assign foreign flights to gates with staff that speak the language of the foreign destination. In another example, the preferences may be for a reduction of distance between the assigned station 114 and a runway for takeoff/landing. The one or more preferences may also include real-time feedback data based on performance of resources 112 and stations 114. For example, if some stations 114 are well-rated by performance ratings (e.g., few delayed flights, higher-rated staff, etc.), those well-rated stations may be preferred for resource assignments. This real-time feedback data may be received by or input to the user device 150, which may relay the ratings to the balancing system 630 for affecting the costs (or weights) accordingly. Another preference may be to avoid changing or altering a pre-existing schedule.

Costs (or weights) for each resource-station assignment may then be determined in accordance with these preferences. As described above with reference to the weight module 134, the preference module 632 may assign lower costs (or weights) to assignments that more closely align with the received preferences. For example, an assignment that would have a flight with a certain operator grouped with other flights having that same operator may have a lower cost (or weight) than an assignment that would assign that flight to a gate in a different terminal or concourse. In another example, an assignment that would assign a foreign flight to an English-only gate may have a higher cost (or weight) than an assignment that would assign that same foreign flight to a gate with staff that speak the language of that foreign destination. In a further example, assignments that would alter the pre-existing schedule may be given higher costs (or weights).

The functional modules 632, 634, and 636 of the balancing system 630 may also include a conflict module 634 configured to receive one or more conflicts, and generate costs for each assignment based on the received conflicts. Similarly to the preference module 632, the conflict module 634 may receive conflicts from a user (e.g., via the user device 150), and may be pre-determined based on the environment 116. The received conflicts may be regarding physical constraints of the environment 116, and may be based in part on equipment or staffing for the resources 112 and/or stations 114. For example, a received conflict may state that two resources may not be towed to adjacent stations 114 at the same time, such that assigning resources to adjacent stations is a conflict. As such, the conflicts may be similar to and overlap with various constraints utilized by the assignment module 136.

The conflict module 634 may generate and assign costs (or weights) to each resource-station assignment based on the received conflicts. Assignments that would result in a violation of the received conflicts may be given a relatively large cost, while assignments that would not result in a violation receive low cost. Assignments that bear a risk of violating conflicts (but do not expressly conflict) may receive a cost higher than that of no-risk but lower than that of a guaranteed conflict.

The functional modules 632, 634, and 636 of the balancing system 630 may also include a balance module 636 configured to adjust the assignments in the solution set 138 based on the costs from the preference module 632 and the conflict module 634. Similarly to the assignment module 136 of the resource assignment system 130, the balance module 636 may determine various sets of resource-station assignments that satisfy one or more constraints, and identify the set having the lowest cost (or weight).

Assigning resources according to systems 100 and 600 as well as methods 400 and 500 may provide numerous benefits over existing assignment methods. First, as described in-depth above, the present methods account for various constraints, requirements, preferences, and conflicts in order to generate a set of assignments that is free of errors and is optimized to include separation between assignments without overlap. Second, the present systems reduce or outright eliminate human input in the assignment of resources. Third, the present systems perform several functions that could not be done by a human, including the generation of several copies of each assignment for testing larger amounts of separation, the consideration of multiple weights across iterations of assignment sets, and the autonomous refreshing of the assignment sets at regular intervals. Fourth, the increased separation reduces the risk of overlapping resources at the same station, which improves utilization levels across gates and reduces unnecessary wait. Fifth, the present systems can operate in parallel to ongoing operations, such that testing of greater amounts of separation via iterative amounts of buffer can be implemented without having to stop operations.

Additionally, the present systems reduce the operating time and costs relative to previous scheduling systems by utilizing a two-stage architecture approach. Due to the relatively large number of constraints and/or preferences, previous systems that attempted to address or solve all in a single run would take hours or days based on the similarly large number of possible solution sets. This large number of possible solution sets can also lead to issues with memory, due to limitations in available memory. Because the present systems utilize a first stage (e.g., system 100) for an initial scheduling based on constraints and separation, and a second stage (e.g., system 600) for balancing based on preferences, the present systems review fewer possible solution sets to determine an optimal solution, which is faster and requires less memory.

Reducing the processing load (e.g., faster solution timing) generally improves the performance of the computer on which the present systems are run, such that the available memory (e.g., memory not dedicated to scheduling) of the computer is increased, the processing capacity of the computer is increased, and the processing speed of the computer is increased. Thus, the present systems improve the functioning of the computer itself. That is, the present systems result in specific improvements in computer capabilities (i.e., reduction of computation time, reduction of required memory, and reduction of processing load). Moreover, due to the decreased amount of time required to solve for an optimal solution, the present systems may be run several times throughout a work day to continue optimizing resource assignments as changes or unforeseen circumstances arise.

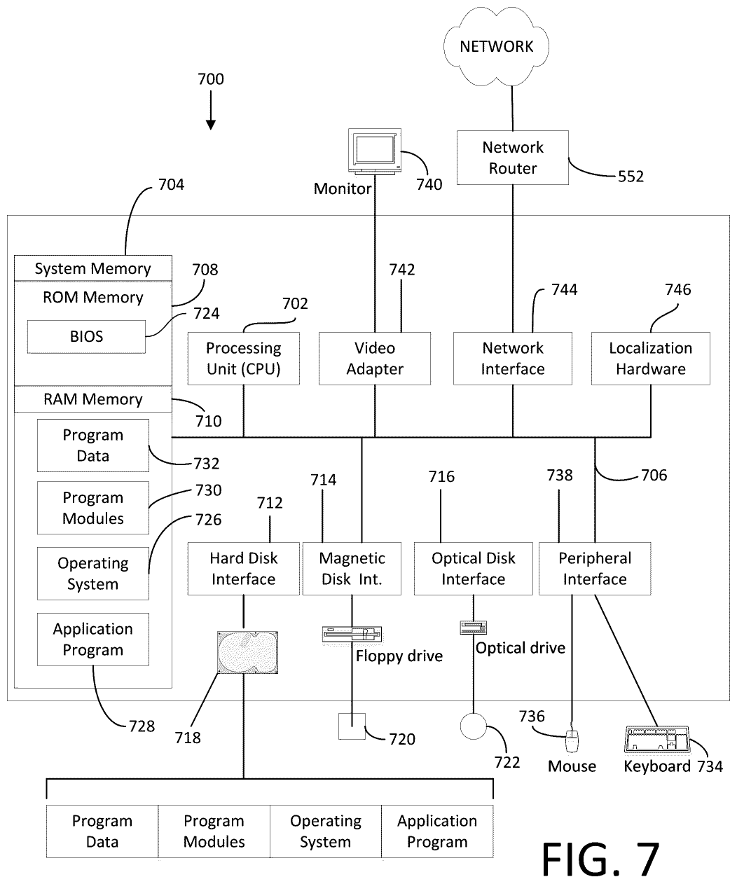

FIG. 7 is a diagrammatic view of an example embodiment of a user computing environment that includes a computing system environment 700, such as a desktop computer, laptop, smartphone, tablet, or any other such device having the ability to execute instructions, such as those stored within a non-transient, computer-readable medium. Furthermore, while described and illustrated in the context of a single computing system, those skilled in the art will also appreciate that the various tasks described hereinafter may be practiced in a distributed environment having multiple computing systems linked via a local or wide-area network in which the executable instructions may be associated with and/or executed by one or more of multiple computing systems.

In its most basic configuration, computing system environment 700 typically includes at least one processing unit 702 and at least one memory 704, which may be linked via a bus. Depending on the exact configuration and type of computing system environment, memory 704 may be volatile (such as RAM 710), non-volatile (such as ROM 708, flash memory, etc.) or some combination of the two. Computing system environment 700 may have additional features and/or functionality. For example, computing system environment 700 may also include additional storage (removable and/or non-removable) including, but not limited to, magnetic or optical disks, tape drives and/or flash drives. Such additional memory devices may be made accessible to the computing system environment 700 by means of, for example, a hard disk drive interface 712, a magnetic disk drive interface 714, and/or an optical disk drive interface 716. As will be understood, these devices, which would be linked to the system bus, respectively, allow for reading from and writing to a hard disk 718, reading from or writing to a removable magnetic disk 720, and/or for reading from or writing to a removable optical disk 722, such as a CD/DVD ROM or other optical media. The drive interfaces and their associated computer-readable media allow for the nonvolatile storage of computer readable instructions, data structures, program modules and other data for the computing system environment 700. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 700.

A number of program modules may be stored in one or more of the memory/media devices. For example, a basic input/output system (BIOS) 724, containing the basic routines that help to transfer information between elements within the computing system environment 700, such as during start-up, may be stored in ROM 708. Similarly, RAM 710, hard disk 718, and/or peripheral memory devices may be used to store computer executable instructions comprising an operating system 726, one or more applications programs 728 (which may include the functionality of the resource assignment system 130 of FIG. 1 or one or more of its functional modules 706, 708, for example), other program modules 730, and/or program data 732. Still further, computer-executable instructions may be downloaded to the computing environment 700 as needed, for example, via a network connection.

An end-user may enter commands and information into the computing system environment 700 through input devices such as a keyboard 734 and/or a pointing device 736. While not illustrated, other input devices may include a microphone, a joystick, a game pad, a scanner, etc. These and other input devices would typically be connected to the processing unit 702 by means of a peripheral interface 738 which, in turn, would be coupled to bus. Input devices may be directly or indirectly connected to processor 702 via interfaces such as, for example, a parallel port, game port, firewire, or a universal serial bus (USB). To view information from the computing system environment 700, a monitor 740 or other type of display device may also be connected to bus via an interface, such as via video adapter 742. In addition to the monitor 740, the computing system environment 700 may also include other peripheral output devices, not shown, such as speakers and printers.

The computing system environment 700 may also utilize logical connections to one or more computing system environments. Communications between the computing system environment 700 and the remote computing system environment may be exchanged via a further processing device, such a network router 752, that is responsible for network routing. Communications with the network router 752 may be performed via a network interface component 744. Thus, within such a networked environment, e.g., the Internet, World Wide Web, LAN, or other like type of wired or wireless network, it will be appreciated that program modules depicted relative to the computing system environment 700, or portions thereof, may be stored in the memory storage device(s) of the computing system environment 700.

The computing system environment 700 may also include localization hardware 746 for determining a location of the computing system environment 700. In embodiments, the localization hardware 746 may include, for example only, a GPS antenna, an RFID chip or reader, a WiFi antenna, or other computing hardware that may be used to capture or transmit signals that may be used to determine the location of the computing system environment 700.

The computing environment 700, or portions thereof, may comprise one or more components of the system 100 of FIG. 1, in embodiments.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments. It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

What is claimed is:

1. A method for assigning a set of resources to a set of stations, the method comprising:
retrieving a set of pre-determined resource assignments, each pre-determined resource assignment comprising a minimum occupancy time for a resource at a station;
generating a set of resource assignment copies, each resource assignment copy associated with a pre-determined resource assignment and comprising a copy occupancy time for the resource at the station, the copy occupancy time comprising the minimum occupancy time and an amount of buffer;
receiving a resource constraint for the set of resources and a station constraint for the set of stations;
assigning a set of first weights to the set of pre-determined resource assignments and a set of second weights to the set of resource assignment copies,
wherein a first weight assigned to a particular resource is greater than a second weight assigned to a copy associated with the particular resource;
determining at least one set of possible resource assignments that satisfies the resource constraint, each of the at least one set of possible resource assignments comprising selected pre-determined resource assignments and selected resource assignment copies;
determining a total weight for each set of the at least one set of possible resource assignments as a sum of the first weights for each selected pre-determined resource assignment and of the second weights for each selected resource assignment copy;
determining a set of solution resource assignments as a set of the at least one set of possible resource assignments having a lowest total weight; and
autonomously presenting the set of solution resource assignments on at least one display.

2. The method of claim 1, wherein:
the set of resources comprise aircraft, and
the set of stations comprise airport gates.

3. The method of claim 2, wherein the minimum occupancy time comprises a period of time between an arrival of the aircraft and a departure of the aircraft.

4. The method of claim 1, wherein the minimum occupancy time is based on:
a beginning time for the resource at the station,
an ending time for the resource at the station, and
a changeover time for the resource.

5. The method of claim 1, wherein the resource constraint comprises that the set of solution resource assignments include either a pre-determined resource assignment or a resource assignment copy for a given resource.

6. The method of claim 1, wherein the station constraint comprises a plurality of station constraints, which further comprise:
a capacity of each of the set of stations to receive each of the set of resources; and
a compatibility of each of the set of stations to receive a type of each of the set of resources.

7. The method of claim 1, wherein the station constraint comprises that a first occupancy time of a first resource assignment to a first gate and a second occupancy time of a second resource assignment to the first gate do not overlap.

8. The method of claim 1, further comprising:
generating a set of second resource assignment copies, each second resource assignment copy associated with a pre-determined resource assignment and comprising a second copy occupancy time for the resource at the station, the copy occupancy time comprising the minimum occupancy time and a second amount of buffer; and
assigning a set of third weights to the set of second resource assignment copies, wherein:
a third weight assigned to a second copy of a particular resource is less than a second weight assigned to a copy associated with the particular resource,
the set of solution resource assignments further comprises selected second resource assignment copies, and
wherein the total weight is determined as the sum of the first weights for each selected pre-determined resource assignment and of the second weights for each selected resource assignment copy.

9. The method of claim 1, further comprising:
receiving one or more resource assignment preferences;
defining a set of resource-station combinations by associating each of the set of solution resource assignments with each of the set of stations;
assigning a set of fourth weights to each of the resource-station combinations, the set of fourth weights determined based on the one or more resource assignment preferences; and
determining a second set of solution resource assignments that satisfies the resource constraint and the station constraint and that minimizes a second total weight,
wherein the second set of solution resource assignments comprises a subset of the set of resource-station combinations, and
wherein the total weight is determined as the sum of the fourth weights for each selected resource-station combination.

10. The method of claim 9, wherein the one or more resource assignment preferences comprise a physical restriction based on the set of stations.

11. The method of claim 9, wherein the one or more resource assignment preferences comprise balancing across the set of stations.

12. The method of claim 9, wherein the one or more resource assignment preferences are determined based on a history of resource assignments.

13. The method of claim 1, wherein the set of solution resource assignments is determined at least once per hour.

14. A method for assigning an aircraft to a gate, the method comprising:
generating a puck for the aircraft comprising an arrival time of the aircraft, a departure time of the aircraft, and a turnover time for the aircraft;
generating a first copy of the puck that adds a first amount of buffer time to the puck;
generating a second copy of the puck that adds a second amount of buffer time to the puck, the second amount of buffer time being greater than the first amount of buffer time;
assigning a first cost to the puck, a second cost to the first copy, and a third cost to the second copy, the first cost being greater than the second cost and the second cost being greater than the third cost;
determining a selected puck as one of the puck, the first copy, or the second copy for an available gate that satisfies a constraint on the aircraft and minimizes a cost;
assigning the aircraft to the available gate; and
autonomously presenting the assignment on at least one display,
wherein:
the constraint is based on the available gate, and
the cost is based on the selected puck.

15. The method of claim 14, wherein the aircraft is a first aircraft, the puck is a first puck, and the gate is a first gate, the method further comprising:
generating a second puck for a second aircraft comprising an arrival time of the second aircraft, a departure time of the second aircraft, and a turnover time for the second aircraft;
generating a first copy of the second puck that adds a first amount of buffer time to the puck;
generating a second copy of the second puck that adds a second amount of buffer time to the puck, the second amount of buffer time being greater than the first amount of buffer time;
assigning a fourth cost to the second puck, a fifth cost to the first copy of the second puck, and a sixth cost to the second copy of the second puck, the fourth cost being greater than the fifth cost and the fifth cost being greater than the sixth cost;
determining a first selected puck for the first gate as one of the first puck, the first copy of the first puck, the second copy of the first puck, the second puck, the first copy of the second puck, or the second copy of the second puck that satisfies a constraint on at least one of the first aircraft or the second aircraft, and minimizes a cost based on the selected puck; and
determining a second selected puck for the second gate as one of the first puck, the first copy of the first puck, the second copy of the first puck, the second puck, the first copy of the second puck, or the second copy of the second puck that satisfies the constraint on at least one of the first aircraft or the second aircraft, and minimizes the cost based on the selected puck.

16. The method of claim 15, further comprising:
receiving one or more aircraft assignment preferences;
assigning a set of weights to each of the first puck, the first copy of the first puck, the second copy of the first puck, the second puck, the first copy of the second puck, and the second copy of the second puck, the set of weights determined based on the one or more aircraft assignment preferences; and
determining an updated first selected puck and an updated second selected puck that satisfies the constraint and that minimizes an updated cost,
wherein the updated cost is determined as the sum of the weights assigned to the updated first selected puck and the updated second selected puck.

17. The method of claim 16, wherein the one or more aircraft assignment preferences comprise a physical restriction based on the first gate or second gate.

18. The method of claim 16, wherein the one or more aircraft assignment preferences comprise balancing across the first gate and second gate.

19. The method of claim 16, wherein the one or more aircraft assignment preferences are determined based on a history of aircraft assignments.

20. A method for dynamically determining a set of weights for resource assignment, the method comprising:
retrieving a set of stations, each station associated with one or more physical constraints;
retrieving a set of resources, each resource associated with one or more physical attributes;
assigning a seed weight for a first resource-station combination, the seed weight indicative of an alignment between the one or more physical attributes of a first resource in the first resource-station combination and the one or more physical constraints of a first station in the first resource-station combination;
autonomously determining at least one resource similar to the first resource based on the one or more physical attributes;
extrapolating the seed weight to generate at least one weight for at least one resource-station combination comprising the at least one similar resource and the first station; and
repeating, for each resource-station combination, the assignment of another seed weight, determination of another at least one similar resource, and the extrapolation to determine the set of weights.

21. A method for assigning a plurality of aircraft to a plurality of gates, the method comprising:
in a first stage:
generating a set of pucks for the plurality of aircraft, each puck comprising a minimum occupancy time for a respective aircraft at a gate;
generating a set of puck copies, each puck copy associated with a generated puck and comprising a copy occupancy time for the respective aircraft, the copy occupancy time comprising the minimum occupancy time and an amount of buffer;
receiving a gate constraint for the plurality of gates and an aircraft constraint for the plurality of aircraft;
assigning a set of first weights to the set of pucks and a set of second weights to the set of puck copies, wherein a first weight assigned to a respective puck is greater than a second weight assigned to a copy associated with the respective puck;
determining at least one set of possible aircraft assignments that satisfies the aircraft constraint and the gate constraint, each of the at least one set of possible aircraft assignments comprising selected pucks and selected puck copies;
determining a total weight for each set of the at least one set of possible aircraft assignments as a sum of the first weights for each selected puck and of the second weights for each selected puck copy; and
determining a set of solution aircraft assignments as a set of the at least one set of possible aircraft assignments having a lowest total weight;
a second stage:
receiving an aircraft assignment preference;
assigning a set of third weights to the set of solution aircraft assignments, the set of third weights based on the aircraft assignment preference;
determining an updated set of solution aircraft assignments that satisfies the aircraft constraint and the gate constraint, and that minimizes an updated cost, the updated weight based on the assigned set of third weights; and
autonomously presenting the updated set of solution resource assignments on at least one display.
